(19) United States
(12) Patent Application Publication
(10) Pub. No.: US 2026/0291351 A1
(43) Pub. Date: Sep. 24, 2026

(54) ROTOR MANUFACTURING DEVICE

(71) Applicant: TOYOTA BOSHOKU KABUSHIKI KAISHA, Aichi-ken (JP)

(72) Inventor: Masaki SUGIYAMA, Okazaki-shi (JP)

(73) Assignee: TOYOTA BOSHOKU KABUSHIKI KAISHA, Aichi-ken (JP)

(21) Appl. No.: 19/473,317

(22) PCT Filed: Mar. 25, 2024
(86) PCT No.: PCT/JP2024/011558

§ 371 Date: Oct. 7, 2025

(30) Foreign Application Priority Data
Apr. 14, 2023 (JP) 2023-066460

(51) Int. Cl. H02K 15/035; H02K 1/276; H02K 15/121

(52) U.S. Cl. CPC H02K 15/035; H02K 15/121; H02K 1/276; H02K 2215/00

(57) ABSTRACT

A rotor manufacturing device includes a first die, a second die, and a gate plate. The gate plate and the second die are provided with a passage for allowing resin injected from a nozzle to flow into accommodation holes when the first die and the second die are clamped. The passage includes bend portions, upstream portions located upstream of the bend portions, and downstream portions located downstream of the bend portions. Resin traps for retaining the resin at an initial stage of injection from the nozzle are each formed at a position adjacent to the corresponding bend portion in the gate plate and aligned with a linear extension of the corresponding upstream portion in the downstream direction.

### TECHNICAL FIELD

The present disclosure relates to a rotor manufacturing device.

### BACKGROUND ART

The rotor of a magnet-embedded motor includes a core formed by stacking iron core pieces in a thickness direction. Such a core includes accommodation holes extending through the core in a stacking direction of the iron core pieces. Each of the accommodation holes accommodates a magnet. These magnets are fixed to the core by filling the accommodation holes with resin. The magnets are fixed to the core by using, for example, a rotor manufacturing device disclosed in Patent Literature 1.

The manufacturing device is an injection molding machine that injects liquid resin into the accommodation holes of the core, and includes a first die, a second die, and a gate plate. The core, with magnets accommodated in the accommodation holes, is disposed between the first die and the second die in an open state. Further, the gate plate is disposed between the core and the second die. The gate plate and the second die are provided with passages for allowing resin injected from the nozzle to flow into the accommodation holes of the core when the first die and the second die are clamped.

The resin injected from the nozzle when the first die and the second die are clamped flows into the accommodation holes accommodating the magnets in the core via the passages formed in the gate plate and the second die. When the resin is solidified, the magnets in the accommodation holes are fixed to the core. Thereafter, when the first die and the second die are opened, the gate plate is separated from the core, and the solidified resin remaining in the passages is removed from the gate plate. Further, the core, to which the magnets have been fixed, is removed from between the first die and the second die in an open state.

The resin for fixing the magnets to the core may be a thermosetting resin or a thermoplastic resin. When a thermoplastic resin is employed, the resin filling the accommodation holes can be solidified earlier than when a thermosetting resin is employed. Specifically, the accommodation holes are filled with the thermoplastic resin melted by heating. Thereafter, the temperature of the thermoplastic resin filling the accommodation holes is lowered, so that the thermoplastic resin is quickly solidified. As a result, when the manufacturing cycle for fixing the magnets to the core using the rotor manufacturing device is repeated, the cycle time per operation can be shortened, thereby improving manufacturing efficiency.

### CITATION LIST

### Patent Literature

Patent Literature 1: WO2016/147211A1

### SUMMARY OF INVENTION

### Technical Problem

However, when a thermoplastic resin is used as the above-described resin, the resin in the nozzle tends to solidify during the interval between completion of one injection and the start of the next injection, as the temperature of the resin within the nozzle decreases. In this case, when injection of the resin from the nozzle begins during clamping of the first die and the second die, the solidified resin first flows from the nozzle into the passages of the gate plate and the second mold. If the solidified resin clogs the passages, it becomes difficult to properly fill the accommodation holes of the core, in which the magnets are accommodated, with molten resin.

### Solution to Problem

In accordance with one aspect of the present disclosure, a rotor manufacturing device includes a first die, a second die, and a gate plate. A core including multiple accommodation holes each accommodating a magnet is disposed between the first die and the second die. The gate plate is disposed between the core and the second die. The gate plate and the second die are provided with a passage for allowing resin injected from a nozzle to flow into the accommodation holes of the core when the first die and the second die are clamped. The rotor manufacturing device fixes the magnets to the core by filling the accommodation holes with the resin. The passage includes one or more bend portions that change a direction in which the resin flows, an upstream portion located upstream of the bend portion in the flow of the resin, and a downstream portion located downstream of the bend portion in the flow of the resin. The gate plate includes one or more resin traps in which the resin at an initial stage of injection from the nozzle is retained. The resin trap is formed at a position adjacent to the bend portion in the gate plate and aligned with a linear extension of the upstream portion in the downstream direction.

### BRIEF DESCRIPTION OF DRAWINGS

FIG. 1 is a perspective view of a core of a rotor.

FIG. 2 is a vertical cross-sectional view of the core shown in FIG. 1.

FIG. 3 is a cross-sectional view of a manufacturing device according to a first embodiment configured to manufacture the rotor shown in FIG. 1.

FIG. 4 is a cross-sectional view of the manufacturing device shown in FIG. 3 during manufacture of the rotor.

FIG. 5 is a cross-sectional view of the manufacturing device shown in FIG. 3 during manufacture of the rotor.

FIG. 6 is a cross-sectional view of the manufacturing device shown in FIG. 3 during manufacture of the rotor.

FIG. 7 is a plan view showing a gate plate in the manufacturing device of FIG. 3, as viewed from the first die.

FIG. 8 is a cross-sectional view of a manufacturing device according to a second embodiment.

FIG. 9 is a cross-sectional view of the manufacturing device shown in FIG. 8 during manufacture of the rotor.

FIG. 10 is a cross-sectional view of the manufacturing device shown in FIG. 8 during manufacture of the rotor.

FIG. 11 is a cross-sectional view of the manufacturing device shown in FIG. 8 during manufacture of the rotor.

FIG. 12 is a cross-sectional view of the manufacturing device shown in FIG. 8 during manufacture of the rotor.

FIG. 13 is a cross-sectional view of a rotor manufacturing device according to a modification.

FIG. 14 is a schematic diagram showing a resin passage in the manufacturing device of FIG. 13 as viewed from above.

FIG. 15 is a schematic diagram of the passage shown in FIG. 14 as viewed from the side.

### DESCRIPTION OF EMBODIMENTS

### First Embodiment

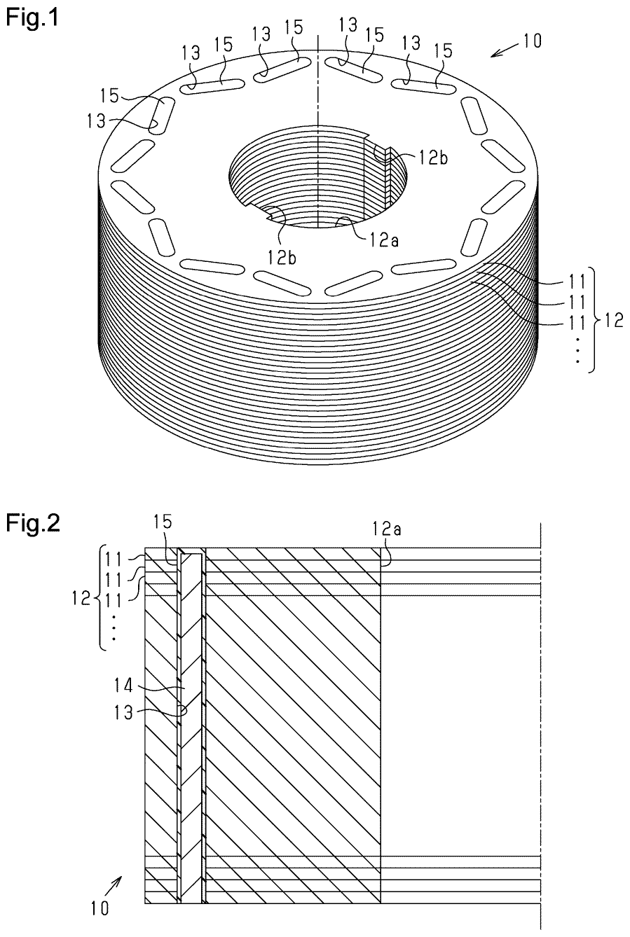

A rotor manufacturing device according to a first embodiment will now be described with reference to FIGS. 1 to 7. As shown in FIG. 1, a rotor 10 of a magnet-embedded motor includes a core 12. The core 12 has a structure achieved by stacking ion core pieces 11, which are disc-shaped magnetic steel sheets, in a thickness direction.

The core 12 has a center hole 12a. The center hole 12a extends along the center line of the core 12. The center hole 12a has two protrusions 12b on the inner circumferential surface. The two protrusions 12b protrude so as to be opposed to each other from the inner circumferential surface of the center hole 12a. The two protrusions 12b extend in the same direction as the center line of the core 12. The core 12 has accommodation holes 13 on the outer side of the center hole 12a. The accommodation holes 13 extend in parallel with the center hole 12a through the core 12. The accommodation holes 13 are arranged around the center line of the core 12 to surround the center line.

As shown in FIG. 2, each accommodation hole 13 accommodates a magnet 14. The accommodation holes 13, which accommodate the magnets 14, are filled with resin 15, so that the magnets 14 are fixed to the core 12. A thermoplastic resin is used as the resin 15. When used as the resin 15 that fills the accommodation holes 13, a thermoplastic resin solidifies more quickly than a thermosetting resin. Accordingly, by using a thermoplastic resin as the resin 15, the magnets 14 accommodated in the accommodation holes 13 are quickly fixed to the core 12.

### Rotor Manufacturing Device

A rotor manufacturing device for manufacturing the rotor 10 by filling the accommodation holes 13 of the core 12 with the resin 15 will now be described.

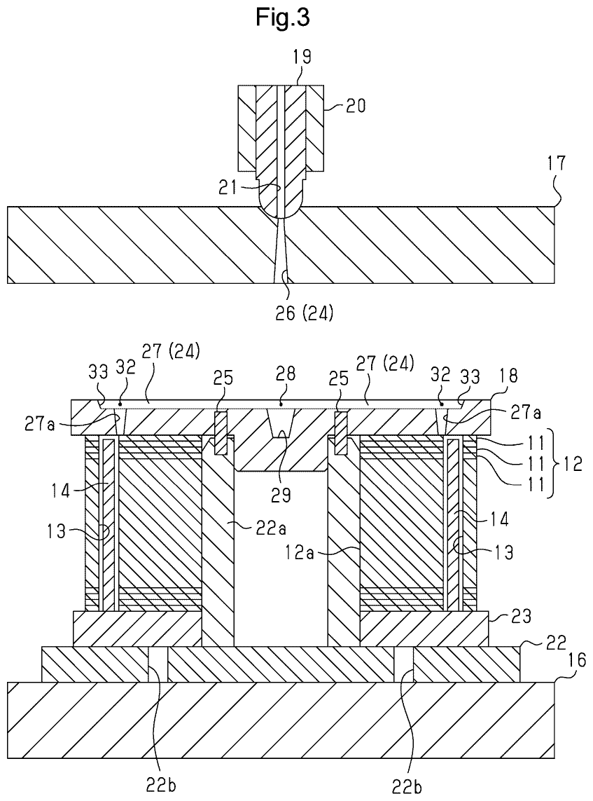

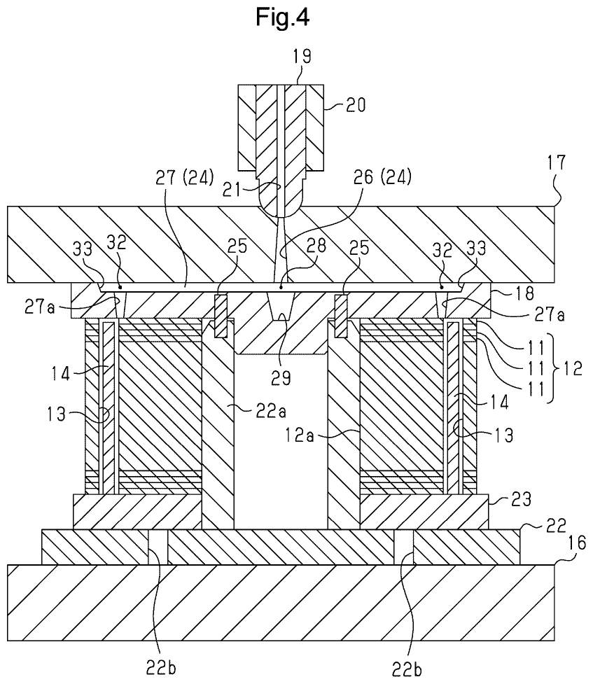

As shown in FIGS. 3 and 4, the rotor manufacturing device includes a first die 16, a second die 17, and a gate plate 18. The first die 16 and the second die 17 are separated away from each other when opened as shown in FIG. 3, and approach each other when clamped as shown in FIG. 4. In the rotor manufacturing device, the first die 16 and the second die 17 are alternately opened and clamped. The second die 17 is provided with a nozzle 19 that injects the resin 15 in a molten state. A heater 20 is disposed around the nozzle 19. The nozzle 19 is heated by the heater 20 to prevent the temperature of the resin 15 in a resin passage 21 of the nozzle 19 from decreasing.

The core 12 before the accommodation holes 13 are filled with the resin 15 is disposed between the first die 16 and the second die 17 in an open state. Specifically, the core 12, with the magnets 14 accommodated in the accommodation holes 13, is disposed between the first die 16 and the second die 17, which are opened together with an intermediate plate 22 and a spacer 23. The intermediate plate 22 is configured to convey the core 12 into the space between the first die 16 and the second die 17 and to convey the core 12 from the space between the first die 16 and the second die 17.

A cylindrical post 22a is fixed to the intermediate plate 22. The post 22a extends through the spacer 23 and the center hole 12a of the core 12. In this state, the spacer 23 is located between the intermediate plate 22 and the core 12. In addition, the positions of the spacer 23 and the core 12 relative to the post 22a in the circumferential direction are fixed. The spacer 23 is used to remove the core 12 from the post 22a. Specifically, the spacer 23 is pressed in a direction away from the intermediate plate 22 by pins or the like inserted into holes 22b of the intermediate plate 22. When the core 12 is pushed by the spacer 23, the core 12 is removed from the post 22a.

The gate plate 18 is disposed between the first die 16 and the second die 17. When the first die 16 and the second die 17 are clamped, the gate plate 18 forms a passage 24 through which the resin 15 injected from the nozzle 19 flows into the accommodation holes 13 of the core 12. The gate plate 18 may be conveyed integrally with the core 12 to the space between the first die 16 and the second die 17, so as to be arranged between the core 12 and the second die 17. The gate plate 18 may be arranged between the core 12 and the second die 17 after the core 12 is conveyed to the space between the first die 16 and the second die 17.

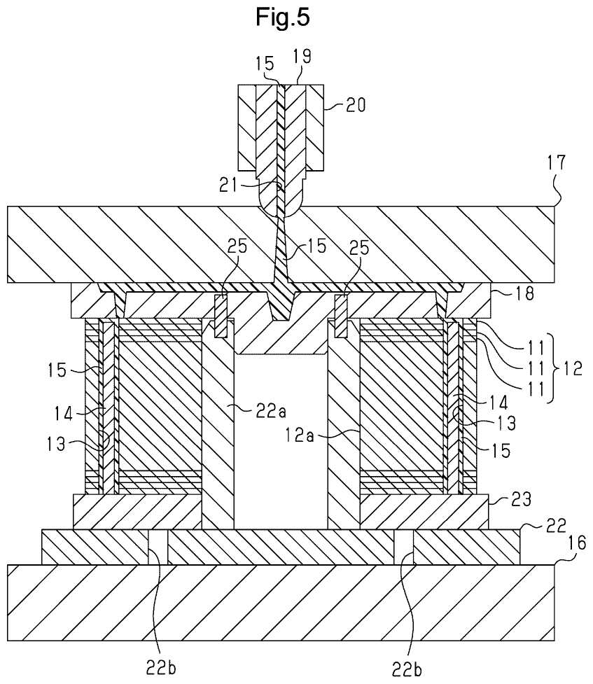

The gate plate 18 disposed between the core 12 and the second die 17 is in contact with the core 12. The position of the gate plate 18 in the circumferential direction in relation to the post 22a of the intermediate plate 22 is fixed by pins 25. When the first die 16 and the second die 17 are clamped, the gate plate 18 and the second die 17 form the passage 24. In this state, as shown in FIG. 5, the molten resin 15 is injected from the nozzle 19, so that the resin 15 flows through the passage 24 and fills the accommodation holes 13 of the core 12. When the resin 15 filling the accommodation holes 13 solidifies, the magnets 14 accommodated in the accommodation holes 13 are fixed to the core 12.

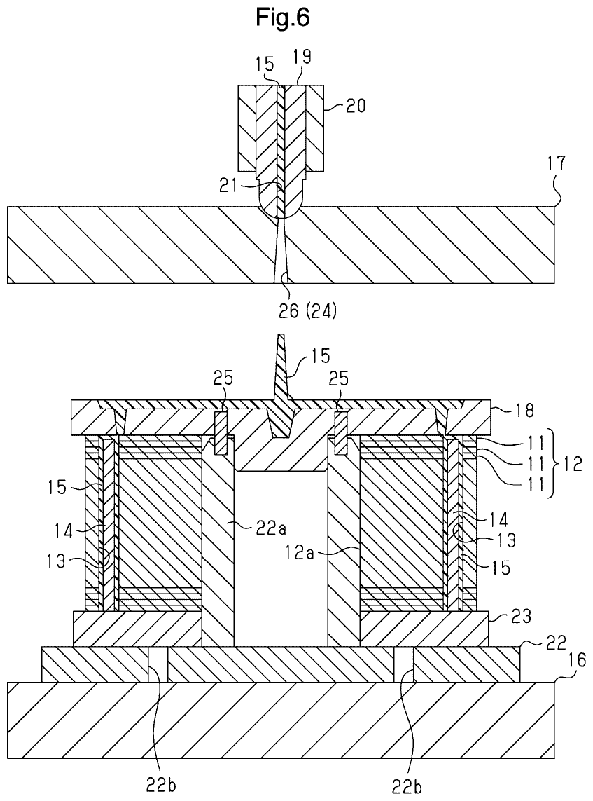

Thereafter, the first die 16 and the second die 17 are opened as shown in FIG. 6. The gate plate 18, which is in contact with the core 12, may be removed from the core 12 and the post 22a when the first die 16 and the second die 17 are opened. The removal of the gate plate 18 from the core 12 and the post 22a may be performed after the core 12 is conveyed together with the intermediate plate 22 from the space between the first die 16 and the second die 17. After being removed from the core 12 and the post 22a, the gate plate 18 is reused after removing the resin 15 that has solidified outside the accommodation holes 13 of the core 12.

### Details of the Passage 24

The passage 24 will now be described in detail.

As shown in FIG. 4, the passage 24 includes a sprue 26 that extends linearly and is connected to the nozzle 19, and multiple runners 27 that branch from the sprue 26. The sprue 26 is formed in the second die 17 so as to extend in a direction in which the first die 16 and the second die 17 approach or separate from each other. The runners 27 extend in a direction orthogonal to the sprue 26 along the boundary between the gate plate 18 and the second die 17 in FIG. 4; that is, in the lateral direction in FIG. 4. The runners 27 are bent to be connected to the accommodation holes 13 of the core 12. A portion of each runner 27 connected to the corresponding accommodation hole 13 is a gate portion 27a.

A portion of the passage 24 at which the sprue 26 and the runners 27 intersect serves as a bend portion 28, which changes the direction in which the resin 15 (FIG. 5) injected from the nozzle 19 flows. The bend portion 28 functions as a first bend portion located at a junction between the sprue 26 and the runners 27.

In the vicinity of the bend portion 28 of the passage 24, the sprue 26 serves as an upstream portion located upstream of the bend portion 28 in the flow of the resin 15, and the runners 27 serve as downstream portions located downstream of the bend portion 28 in the flow of the resin 15. The gate plate 18 includes a resin trap 29 at a position adjacent to the bend portion 28 and aligned with a linear extension of the sprue 26 in the downstream direction. The resin trap 29 is formed at a position corresponding to the bend portion 28.

The temperature of the resin 15 within the resin passage 21 of the nozzle 19 decreases between the end of one injection of the resin 15 from the nozzle 19 and the start of the next, which may cause the resin 15 to begin solidifying. In order to limit such a temperature drop, the nozzle 19 is heated by the heater 20. However, in a region of the resin passage 21 at the tip of the nozzle 19, which is covered by the heater 20, the temperature of the resin 15 inevitably decreases. Therefore, solidification of the resin 15 progresses in the region of the resin passage 21 at the tip of the nozzle 19, which is not covered by the heater 20, during the interval before the next injection of resin 15.

As a result, solidified resin 15 located near the nozzle tip is discharged at the initial stage of the subsequent injection of the resin 15 from the nozzle 19. The resin trap 29 is configured to retain the solidified resin 15 at the initial stage of injection from the nozzle 19. The volume V of the resin trap 29 is greater than the volume of the region of the resin passage 21 at the tip of the nozzle 19, which is not covered by the heater 20.

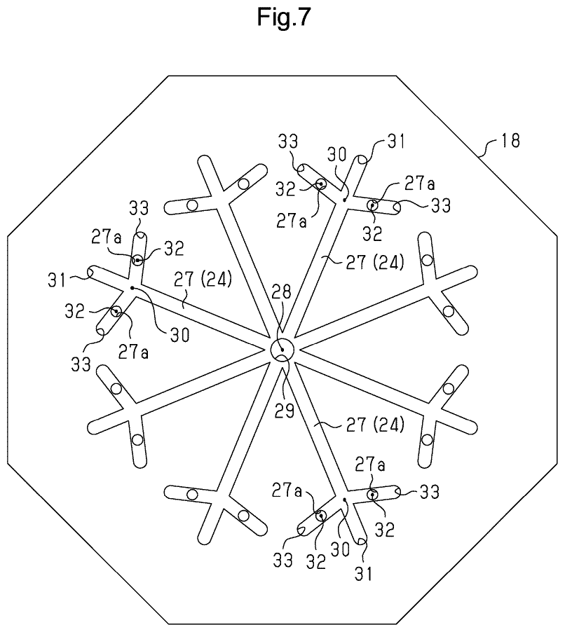

FIG. 7 shows the gate plate 18 of FIG. 4 as viewed from the first die 16. As shown in FIG. 7, each of the runners 27 branches at an end on a side opposite to the end close to the first bend portion 28 so as to be connected to two of the gate portions 27a. The branching portion of the runner 27 serves as a bend portion 30 that changes the flow direction of the resin 15. The bend portion 30 functions as a second bend portion located at a bent section of the runner 27.

In the vicinity of each bend portion 30 of the passage 24, a portion of the runner 27 closer to the bend portion 28 than the bend portion 30 is serves as an upstream portion located upstream of the bend portion 30 in the flow of the resin 15. A portion of the runner 27 closer to each of the gate portions 27a than the bend portion 30 is serves as a downstream portion located downstream of the bend portion 30 in the flow of the resin 15. A resin trap 31 is formed at a position in the gate plate 18 adjacent to each bend portion 30 and aligned with a linear extension in the downstream direction of a portion of the runner 27 closer to the bend portion 28 than the bend portion 30 is. The resin trap 31 is formed at a position corresponding to the bend portion 30.

A portion of each runner 27 that is downstream of the bend portion 30 and is connected to the corresponding gate portion 27a is a bend portion 32, which changes the flow direction of the resin 15. The bend portion 32 functions as a second bend portion located at a bent section of the runner 27.

In the vicinity of each bend portion 32 of the passage 24, a portion of the runner 27 closer to the bend portion 30 than the bend portion 32 is serves as an upstream portion located upstream of the bend portion 32 in the flow of the resin 15. Each gate portion 27a of each runner 27 serves as a downstream portion located downstream of the bend portion 32 in the flow of the resin 15. A resin trap 33 is formed at a position in the gate plate 18 adjacent to each bend portion 32 and aligned with a linear extension in the downstream direction of a portion of the runner 27 closer to the bend portion 30 than the bend portion 32 is. The resin trap 33 is formed at a position corresponding to the bend portion 32.

The multiple bend portions 28, 30, 32 are present at intervals in the flow direction of the resin 15 in the passage 24. The multiple resin traps 29, 31, 33 are located at positions corresponding to the respective bend portions 28, 30, 32. Among the bend portions 28, 30, 32, the bend portion 28 is a bend portion that the resin 15 injected from the nozzle 19 reaches first. The resin trap 29, which has the above-described volume V, is formed so as to be located at a position corresponding to the bend portion 28. Similarly to the resin trap 29, the resin traps 31, 33 are configured to retain solidified resin 15 at the initial stage of injection from the nozzle 19.

Operation and advantages of the rotor manufacturing device according to the present embodiment will now be described.
(1) When a thermoplastic resin is used as the resin 15 to be supplied to the accommodation holes 13 of the core 12, in which the magnets 14 are housed, the following occurs. When the injection of the resin 15 from the nozzle 19 is started at the time of clamping the first die 16 and the second die 17, the solidified resin 15 first flows from the nozzle 19 to the gate plate 18 and the passages 24 of the second die 17. When solidified resin 15 passes through each of the bend portions 28, 30, 32 of the passage 24, the resin 15 advances from the upstream side to the downstream side of the bend portion 28, 30, 32 without changing the flow direction, and thus enters and remains in the resin trap 29, 31, 33. Since the solidified resin 15 is trapped by the resin trap 29, 31, 33, the resin 15 is prevented from flowing to the downstream side along the passage 24. Then, molten resin 15 behind the solidified resin 15 is supplied to the accommodation holes 13 of the core 12 through the downstream portions of the passage 24. Therefore, it is possible to prevent the passage 24 from being clogged by the solidified resin 15 flowing to the downstream portions of the passage 24, and it is possible to prevent the accommodation holes 13 of the core 12 from being unable to be appropriately filled with the resin 15 due to such clogging. As a result, it is possible to appropriately fill the accommodation holes 13 accommodating the magnets 14 in the core 12 with the thermoplastic resin.
(2) If a gate portion 27a of any runner 27 of the passage 24 is clogged by solidified resin 15, resin 15 under a relatively high pressure flows into the other gate portion 27a of the same runner 27. When the resin 15 under a relatively high pressure flows into the corresponding accommodation hole 13, the filling pressure of the resin 15 in the accommodation hole 13 increases, which may deform the core 12. However, by preventing clogging in the gate portions 27a, the occurrence of deformation in the core 12 is prevented.
(3) The bend portions 28, 30, 32 are provided in the passage 24 at intervals in the flow direction of the resin 15. The resin traps 29, 31, 33 are formed at positions corresponding to the respective bend portions 28, 30, 32. Accordingly, solidified resin 15, which is the resin 15 at the initial stage of injection from the nozzle 19, is trapped by any one of the resin traps 29, 31, 33, and thus the solidified resin 15 is unlikely to flow to the downstream portion of the passage 24. As a result, the passage 24 is more reliably prevented from being clogged with solidified resin 15.
(4) The resin trap 29 is formed at the position corresponding to the bend portion 28, which the resin 15 injected from the nozzle 19 reaches first. Accordingly, the solidified resin 15 is trapped in the resin trap 29 at an early stage when the solidified resin 15 flows into the passage 24 at the initial stage of injection from the nozzle 19.
(5) The nozzle 19 is heated by the heater 20 so that the resin 15 in the nozzle 19 is not solidified. Even in this case, it is difficult to dispose the heater 20 at the tip of the nozzle 19. Accordingly, in the region of the resin passage 21 at the tip of the nozzle 19 that is not covered by the heater 20, the resin 15 tends to solidify. In this regard, the volume V of the resin trap 29 is greater than the volume of the region of the resin passage 21 at the tip of the nozzle 19, which is not covered by the heater 20. Accordingly, the solidified resin 15 in the initial stage of injection from the nozzle 19 can be easily trapped by the resin trap 29.
(6) The passage 24 includes the sprue 26, which extends linearly and is connected to the nozzle 19, and the runners 27, which branch from the sprue 26. The runners 27 are bent to be connected to the accommodation holes 13. The bend portion 28 functions as the first bend portion, located at the junction between the sprue 26 and the runners 27. The bend portions 30, 32 each function as the second bend portion located at a bent section of each runner 27. The resin trap 29 is formed at the position corresponding to the bend portion 28. The resin traps 31, 33 are formed at the positions corresponding to the respective bend portions 30, 32. Accordingly, solidified resin 15 at the initial stage of injection from the nozzle 19 is trapped in the resin trap 29, which is located at the position corresponding to the bend portion 28, at an early stage after the resin injection. Further, the solidified resin 15 that cannot be trapped by the resin trap 29 is trapped by the resin traps 31, 33 located at positions corresponding to the bend portions 30, 32. The resin traps 29, 31, 33 thus more reliably prevent the solidified resin 15 from flowing to the downstream portions of the passage 24.

### Second Embodiment

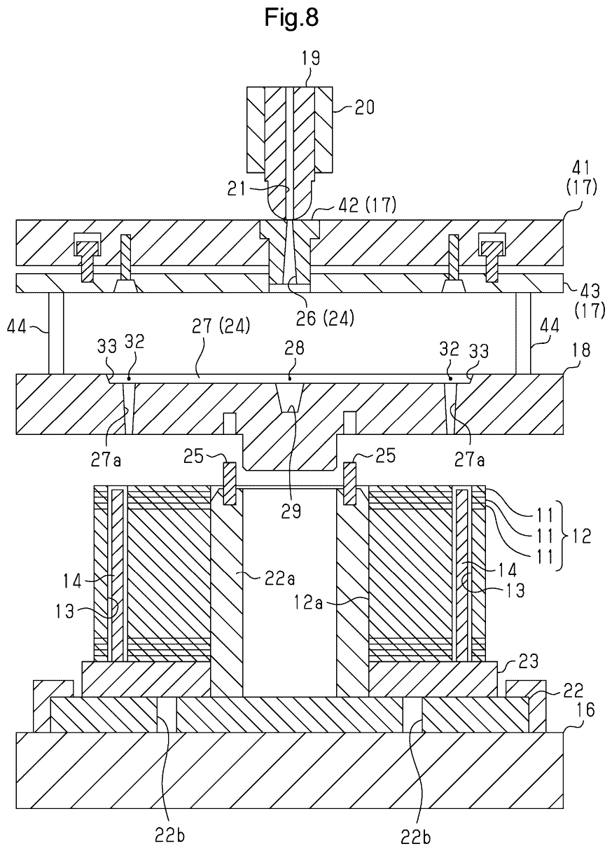

A rotor manufacturing device according to a second embodiment will now be described with reference to FIGS. 8 to 12.

As shown in FIG. 8, the rotor manufacturing device of this embodiment is different from the rotor manufacturing device of the first embodiment in that a gate plate 18 is incorporated in the second die 17. As shown in FIG. 8, the second die 17 includes a body block 41, a passage block 42, and an eject block 43.

The eject block 43 is disposed closer to the first die 16 than the body block 41 is. The passage block 42 extends through the body block 41 and the eject block 43 in a direction in which the first die 16 and the second die 17 approach and separate from each other; that is, in the vertical direction in FIG. 8. The passage block 42 is used to form the sprue 26 of the passage 24. The eject block 43 is movable relative to the body block 41 and the passage block 42 in a direction toward and away from the body block 41.

The gate plate 18 is disposed closer to the first die 16 than the eject block 43 is. The gate plate 18 is connected to the body block 41 and the eject block 43 via guide bars 44. The gate plate 18 is movable toward and away from the body block 41 and the eject block 43. The relative movement of the gate plate 18 is guided by the guide bars 44.

The core 12, with the magnets 14 accommodated in the accommodation holes 13, is disposed, together with the intermediate plate 22 and the spacer 23, between the first die 16 and the second die 17 in an open state; specifically, between the gate plate 18 and the first die 16. Thereafter, when the first die 16 and the second die 17 are clamped, the gate plate 18 comes into contact with the core 12, and the eject block 43 comes into contact with the gate plate 18 and the body block 41. At this time, the passage 24 is formed in the second die 17 and the gate plate 18.

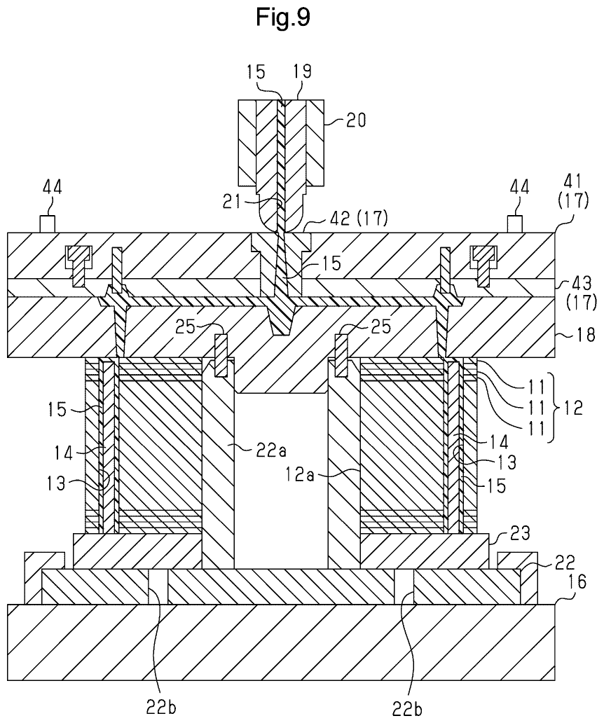

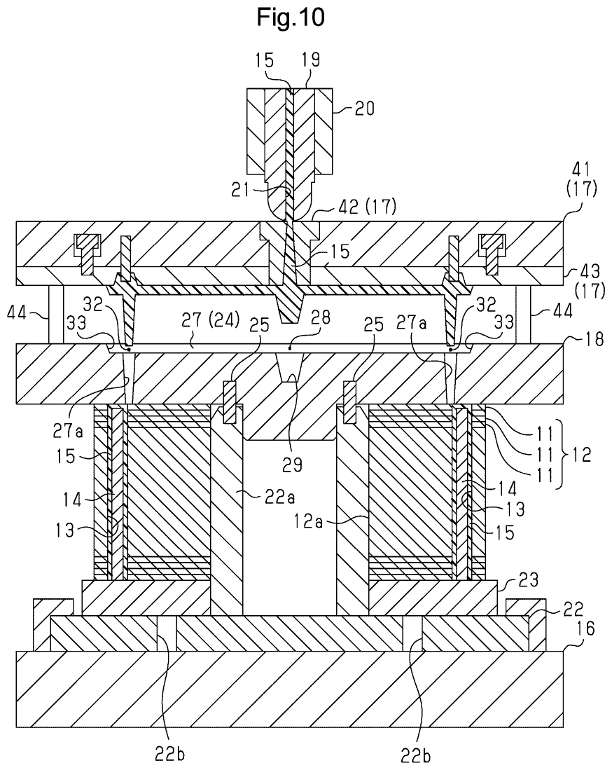

When the first die 16 and the second die 17 are clamped, molten resin is injected from the nozzle 19 into the accommodation holes 13 of the core 12 through the passage 24 as shown in FIG. 9. Thereafter, as shown in FIGS. 10 to 12, the first die 16 and the second die 17 are opened. Specifically, as shown in FIG. 10, the body block 41, the passage block 42, and the eject block 43 are moved away from the gate plate 18. Accordingly, the resin 15 solidified in the passage 24 at the time of die clamping is pulled out from the gate plate 18 together with the body block 41 and the eject block 43.

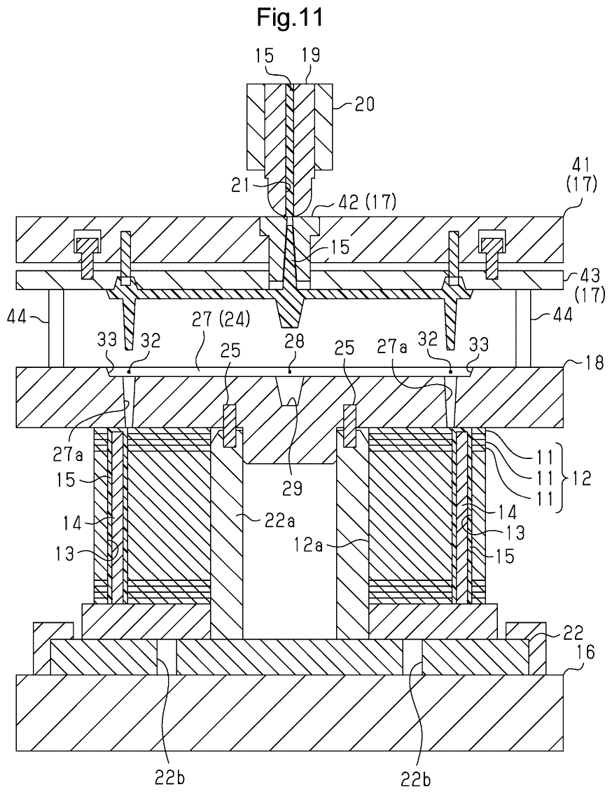

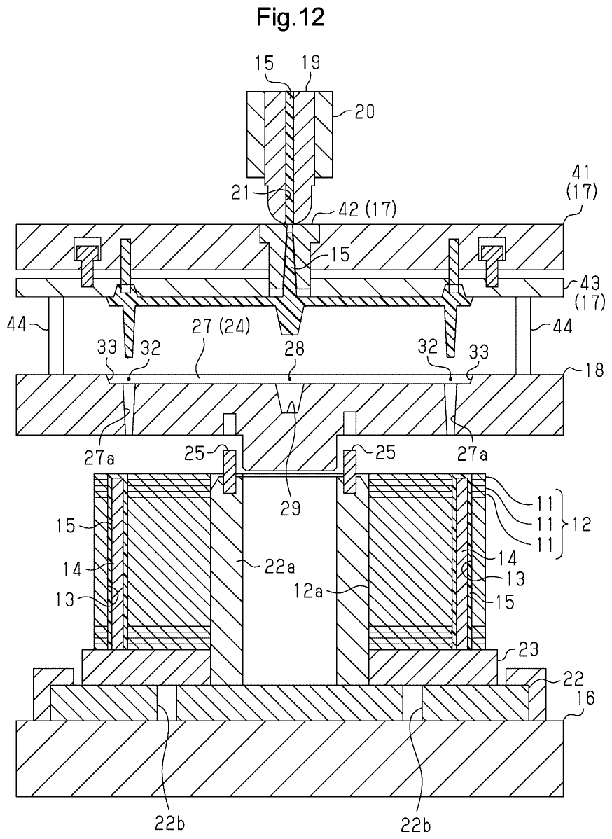

Thereafter, as shown in FIG. 11, the eject block 43 is moved away from the body block 41. As a result, the resin 15 is displaced in the direction in which the resin 15 is removed from the passage block 42. Further, as shown in FIG. 12, the body block 41, the passage block 42, the eject block 43, and the gate plate 18 are moved away from the first die 16. In this state, the resin 15 is removed from the passage block 42 and the eject block 43.

The present embodiment has the same advantage as (1) to (6) of the first embodiment.

### Other Embodiments

The above-described embodiment may be modified to the forms described below, for example. The above-described embodiment and the following modifications can be combined if the combined modifications remain technically consistent with each other.

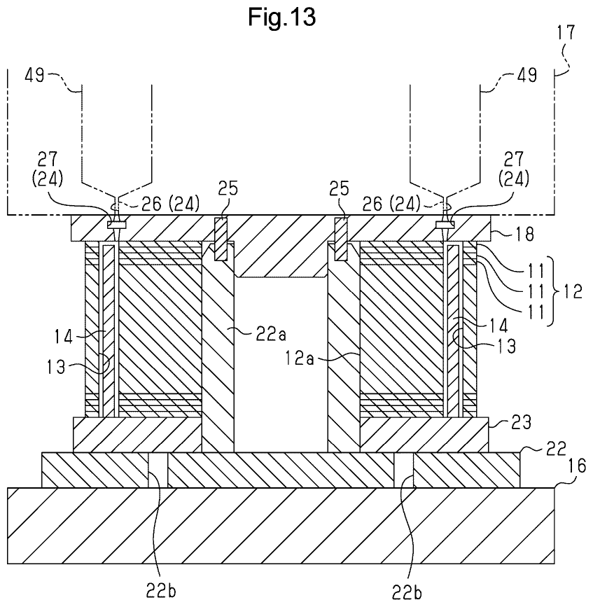

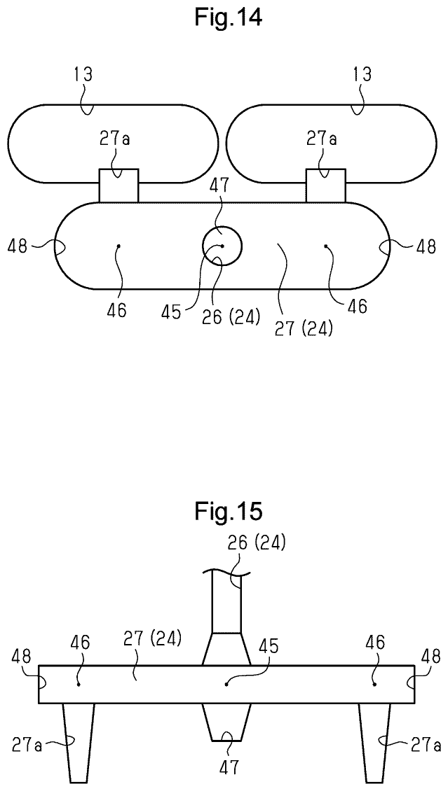

Instead of the nozzle 19, as shown in FIG. 13, nozzles 49 functioning as hot runners may be disposed in the second die 17. In this case, as shown in FIGS. 14 and 15, bend portions 45, 46 are formed in parts of the passage 24 that are located in the gate plate 18. Further, resin traps 47, 48 are formed in the gate plate 18 at positions corresponding to the bend portion 45, 46.
Among the resin traps 29, 31, 33, at least one may be retained while the others are omitted.
The volume V of the resin trap 29 may be changed.

1-5. (canceled)

6. A rotor manufacturing device, comprising a first die, a second die, and a gate plate, wherein
a core including multiple accommodation holes each accommodating a magnet is disposed between the first die and the second die,
the gate plate is disposed between the core and the second die,
the gate plate and the second die are provided with a passage for allowing resin injected from a nozzle to flow into the accommodation holes of the core when the first die and the second die are clamped,
the rotor manufacturing device fixes the magnets to the core by filling the accommodation holes with the resin,
the passage includes:
one or more bend portions that change a direction in which the resin flows;
an upstream portion located upstream of the bend portion in the flow of the resin; and
a downstream portion located downstream of the bend portion in the flow of the resin,
the gate plate includes one or more resin traps in which the resin at an initial stage of injection from the nozzle is retained,
the resin trap is formed at a position adjacent to the bend portion in the gate plate and aligned with a linear extension of the upstream portion in the downstream direction, the passage includes:
a sprue extending linearly and connected to the nozzle; and
multiple runners branching from the sprue,
the one or more bend portions include a first bend portion located at a junction between the sprue and the runners,
each runner includes two gate portions, each of the two gate portions being connected to a corresponding one of the multiple accommodation holes,
each of the runners branches at an end on a side opposite to the end close to the first bend portion so as to be connected to the two gate portions,
the one or more bend potions include second bend portions each formed by a section of each runner that is connected to the two gate portions,
the two second bend portions of each runner are located downstream of the branching section of the runner, and
the one or more resin traps include resin traps formed at positions respectively corresponding to the two second bend portions of each runner.

7. The rotor manufacturing device according to claim 6, wherein the one or more resin traps include a resin trap formed at a position corresponding to the first bend portion.

8. The rotor manufacturing device according to claim 7, wherein a volume of the resin trap formed at the position corresponding to the first bend portion is greater than a volume of a region in a resin passage at a tip of the nozzle that is not covered by a heater.
